(19) United States
(12) Patent Application Publication
(10) Pub. No.: US 2016/0187997 A1
(43) Pub. Date: Jun. 30, 2016

(54) METHOD AND DEVICE FOR CONTROLLING APPLICATION

(71) Applicant: Xiaomi Inc., Beijing (CN)

(72) Inventors: Sitai Gao, Beijing (CN); Wenxing Shen, Beijing (CN)

(21) Appl. No.: 15/052,816

(22) Filed: Feb. 24, 2016

Related U.S. Application Data
(63) Continuation of application No. PCT/CN2015/093862, filed on Nov. 5, 2015.

(30) Foreign Application Priority Data
Dec. 31, 2014 (CN) 201410856869.6

(51) Int. Cl. G06F 3/02; G06F 3/0484; G06F 3/0488

(52) U.S. Cl. CPC G06F 3/02; G06F 3/04883; G06F 3/0484

(57) ABSTRACT

A method and a device for controlling an application are provided to conveniently and accurately control applications. The method includes: receiving a triggering operation on a physical key; determining an application operation corresponding to the triggering operation on the physical key for a current application; and performing the application operation for the current application.

### CROSS-REFERENCE TO RELATED APPLICATIONS

This application is a Continuation of International Application No. PCT/CN2015/093862, filed Nov. 5, 2015, which is based upon and claims priority to Chinese Patent Application No. 201410856869.6 filed Dec. 31, 2014, the entire contents of which are incorporated herein by reference.

### TECHNICAL FIELD

The present disclosure generally relates to the field of communication and computer processing, and more particularly, to a method and a device for controlling an application.

### BACKGROUND

With the development of electronic technologies, mobile terminals have become increasingly prevalent across the world, and they are updated very fast. Input devices of mobile terminals have evolved from original physical keyboards to touch screens, and full touch screen mobile terminals have become the main stream.

### SUMMARY

The present disclosure provides a method and a device for controlling an application.

According to a first aspect of embodiments of the present disclosure, there is provided a method for controlling an application, including: receiving a triggering operation on a physical key; determining an application operation corresponding to the triggering operation on the physical key for a current application; and performing the application operation to the current application.

According to a second aspect of embodiments of the present disclosure, there is provided a device for controlling an application, including: a processor; and a memory for storing instructions executable by the processor; wherein the processor is configured to perform: receiving a triggering operation on a physical key; determining an application operation corresponding to the triggering operation on the physical key for a current application; and performing the application operation to the current application.

According to a third aspect of embodiments of the present disclosure, there is provided a non-transitory computer-readable storage medium having stored therein instructions that, when executed by a processor of a device, causes the device to perform a method for controlling an application, the method including: receiving a triggering operation on a physical key; determining an application operation corresponding to the triggering operation on the physical key for a current application; and performing the application operation to the current application.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for controlling an application according to an exemplary embodiment.

FIG. 2 is a diagram showing an application interface according to an exemplary embodiment.

FIG. 3 is a diagram showing an application interface according to an exemplary embodiment.

FIG. 4 is a diagram showing an application interface according to an exemplary embodiment.

FIG. 5 is a diagram showing an application interface according to an exemplary embodiment.

FIG. 6 is a diagram showing an application interface according to an exemplary embodiment.

FIG. 7 is a diagram showing a configuration interface according to an exemplary embodiment.

FIG. 8 is a flowchart showing a method for controlling an application according to an exemplary embodiment.

FIG. 9 is a flowchart showing a method for controlling an application according to an exemplary embodiment.

FIG. 10 is a block diagram showing an apparatus for controlling an application according to an exemplary embodiment.

FIG. 11 is a block diagram showing a determining module according to an exemplary embodiment.

FIG. 12 is a block diagram showing an executing module according to an exemplary embodiment.

FIG. 13A is a block diagram showing a determining module according to an exemplary embodiment.

FIG. 13B is a block diagram showing a determining module according to an exemplary embodiment.

FIG. 14 is a block diagram showing a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

In related arts, most mobile terminals are not provided with a physical keyboard but employ a full touch screen input. A mobile terminal with a full touch screen input usually has a small number of physical keys (or hardware keys) such as a power key and one or more volume keys.

The inventors of the present disclosure have found that the physical keys may provide tactile feedbacks for users. A user may know whether an operation is successful or not by the tactility of pressing a physical key, even without viewing a screen. When it is not convenient for a user to view the screen or when it is not convenient for a user to perform operations on the screen, the physical key may make the user's operations easier. Thus, it is desired to have the physical keys to incorporate functions more than powering on or off the mobile terminal and adjusting volume.

A possible solution is to negotiate with application managers in advance to request them to open specific internal interfaces of their applications. Then, a developer should become familiar with the specific internal interfaces of these applications and make the specific internal interface of each application adapt to the physical keys. In practical operations, when a user presses a physical key, a mobile terminal calls the specific internal interface adapt to the physical key, and thereby controls the application via the physical key.

In embodiments of the present disclosure, a solution that does not require knowledge of specific internal interfaces of the applications and calling the specific internal interfaces of these applications is proposed. When a physical key is triggered, an operation in the user interface of the application is performed and thereby the application can be controlled. Thus, the tactile advantage of physical keys can be realized in controlling applications in a terminal with a full touch screen. Consequently, a user may know the operation results more clearly. Further, a method for controlling an application is provided herein.

The physical keys in the embodiments of the present disclosure include a home key, a power key, a volume key and an additional control key and the like.

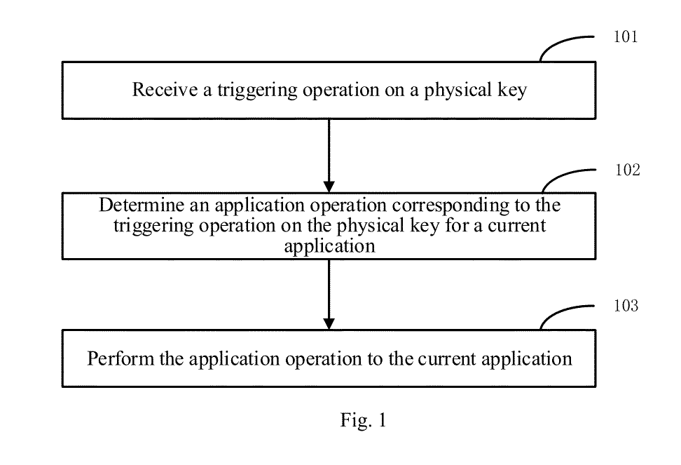

FIG. 1 is a flowchart showing a method for controlling an application according to an exemplary embodiment. As shown in FIG. 1, the method is implemented by a mobile terminal and may include the following steps.

In step 101, a triggering operation on a physical key is received.

In step 102, an application operation corresponding to the triggering operation on the physical key is determined for a current application.

In step 103, the application operation is performed to the current application.

In the embodiment, a user may start a certain application, and press a physical key when this application is running, for example, running in foreground. The mobile terminal receives a triggering operation on the physical key for the application, for example, single click, double click or long pressing and the like. Different from a user pressing a physical key in a home screen, when the triggering operation on the physical key is received after entering into the application interface of the application, the mobile terminal may perform corresponding application operations to the application according to pre-configured triggering operations on the physical key so as to control the application. For different applications, different controls may be realized by pressing the same physical key. If the triggering operation on the physical key is received in the home screen, the mobile terminal can only control a particular single application. Further, the control of application in the present embodiment is realized by performing application operations, and the application managers do not need to open access to the specific internal interfaces of their applications, and professionals do not need to have knowledge of the specific internal interfaces of the applications. Thus, the embodiments of the present disclosure are better in compatibility and extendibility, and it is only required to update the correspondence between triggering operations on physical keys and application operations of applications.

In an embodiment, the application operation includes a gesture operation and an object of the gesture operation.

The application operation may be various operations, including a gesture operation to an interface, or a gesture operation to a virtual button, for example. For a gesture operation to an interface, the interface is the object of the gesture operation. For a gesture operation to a virtual button, the virtual button is the object of the gesture operation.

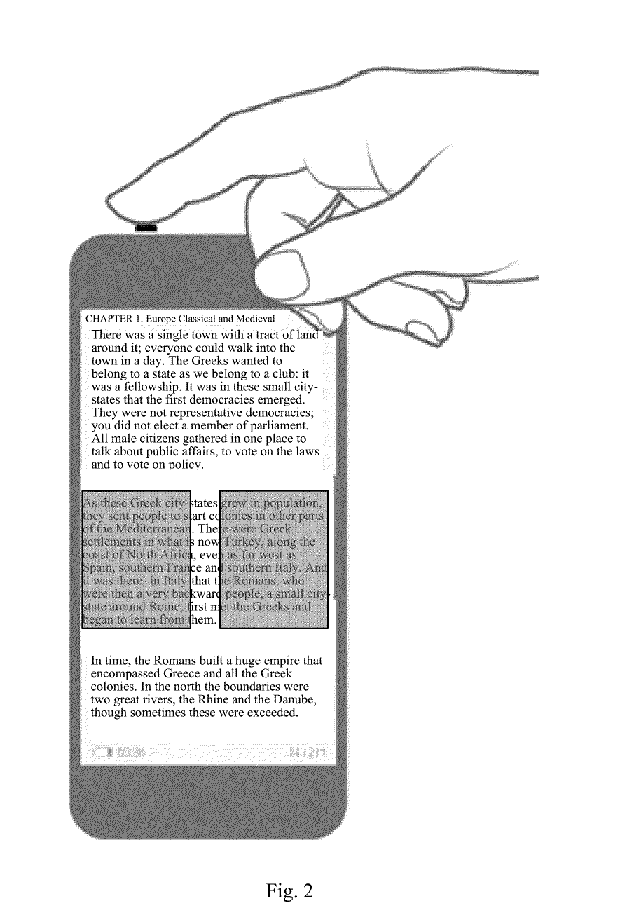

For example, the application is a reader application and the triggering operation to a physical key includes a single click and a double click. The single click corresponds to a gesture operation of sliding to the left or a single tap on the left area of the interface, which controls the application to turn to a previous page. The double click corresponds to a gesture operation of sliding to the right or a single tap on the right area of the interface, which controls the application to turn to a next page. For the reader application, every time the user presses (single click) on the physical key, the mobile terminal is triggered by the single click, and then the mobile terminal determines that the triggering operation by the single click corresponds to a single tap on the left area in the reader interface, as shown in FIG. 2. Then, the mobile terminal performs a single tap gesture operation on the left area, which is equivalent to generating a gesture instruction indicating a single tap on the left area. After that, the mobile terminal sends the gesture instruction to the reader application. After receiving the gesture instruction, the reader application performs the operation of turning to the previous page. Alternatively, if the user conducts two consecutive pressing actions (double click) on the physical key, the mobile terminal is triggered by the double click, and determines that the triggering operation of the double click corresponds to a single tap on the right area of the interface of the reader application, as shown in FIG. 2. Then, the mobile terminal performs a single tap gesture operation on the right area of the interface of the reader application, which is equivalent to generating a gesture instruction indicating a single tap on the right area, and then sends the gesture instruction to the reader application. After receiving the gesture instruction, the reader application performs the operation of turning to the next page.

For different application interfaces, the triggering operation on the same physical key may correspond to different gesture operations. Thus, it is convenient to flexibly control different applications.

When the application operation includes a gesture operation on a virtual button, step 102 may be realized by steps A1 and A2, and step 103 may be realized by step A3.

In step A1, a virtual button and a gesture operation corresponding to the triggering operation on the physical key in the current interface of the current application are determined.

In step A2, the virtual button is identified in the current interface and coordinates of the virtual button in the current interface are determined.

In step A3, the gesture operation is performed at the coordinates in the current interface of the current application.

In the present embodiment, the triggering operation on a physical key may correspond to different application operations in different interfaces of a single application. That is to say, various virtual buttons may be controlled by the triggering operation on the physical key. Thus, various controls may be performed to a single application by the physical key, and the controls are more flexible and convenient.

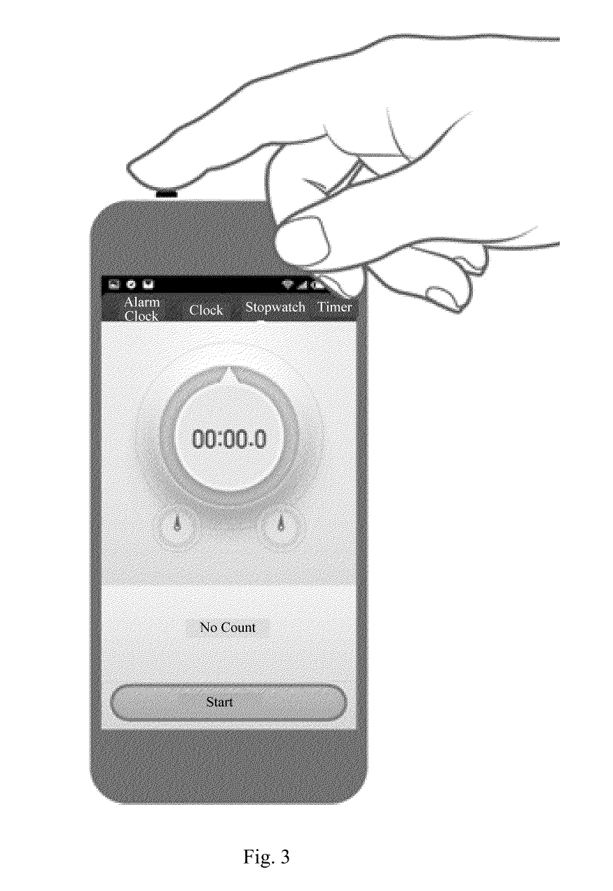

For example, in a home page of a stopwatch application, as shown in FIG. 3, the single click on the physical key corresponds to tapping the “Start” button. A user may start the stopwatch application and then press the physical key. After receiving the triggering operation on the physical key, the mobile terminal determines the current application and its current interface. If the mobile terminal determines that the current application is the stopwatch application and the current interface is the home page of the stopwatch application, the mobile terminal may inquire the correspondence between triggering operations on physical keys and application operations, and then determines that the application operation is a single tap operation to the “Start” button. The mobile terminal may perform the single tap operation to the “Start” button. Then, the stopwatch application starts time-counting. If the user presses the physical key in a time-counting page of the stopwatch application, the mobile terminal receives the triggering operation on the physical key, and determines the current application and the current interface of the current application. If the mobile terminal determines that the current application is the stopwatch application and the current interface is the time-counting page, the mobile terminal may inquire the correspondence between triggering operations on physical keys and application operations, and determines that the application operation corresponds to a single tap operation to the “Stop” button. The mobile terminal may perform the single tap operation to the “Stop” button, and then the stopwatch application stops time-counting.

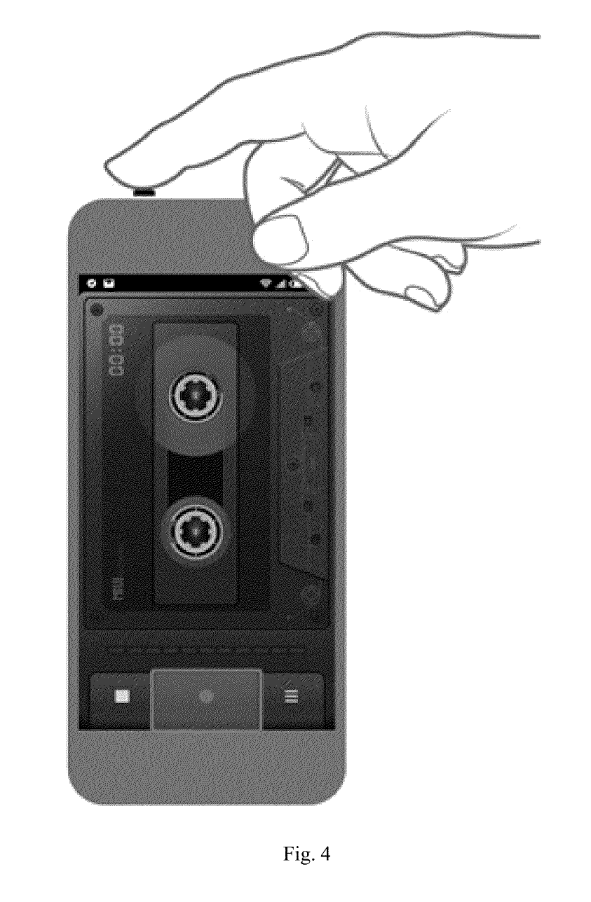

Taking a recording application as another example, in a home page of the recording application, as shown in FIG. 4, single click on the physical key corresponds to a tap on the “Start” button. After a user presses the physical key, the recording application starts to record. In a recording interface, single click on the physical key corresponds to an application operation of pausing recording, which is equivalent to a tap on the “Pause” button. Two times of pressing on the physical key corresponds to an application operation of stopping recording, which is equivalent to a tap on the “Stop” button.

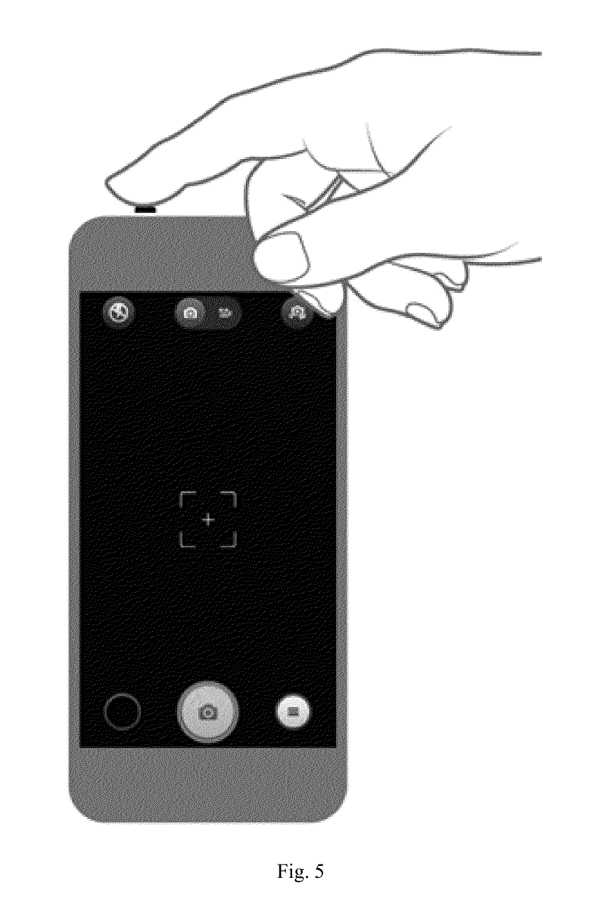

Taking a camera application as another example, in a home page of the camera application, as shown in FIG. 5, a single click on the physical key corresponds to a tap on the “Take a photo” button. After a user presses the physical key, the camera application starts to take photos, each pressing action on the physical key may instruct to take a photo. Long pressing on the physical key corresponds to long pressing on the “Take a photo” button. After the user continuously presses the physical key, the camera application starts to take photos continuously to realize continuous photo-capturing.

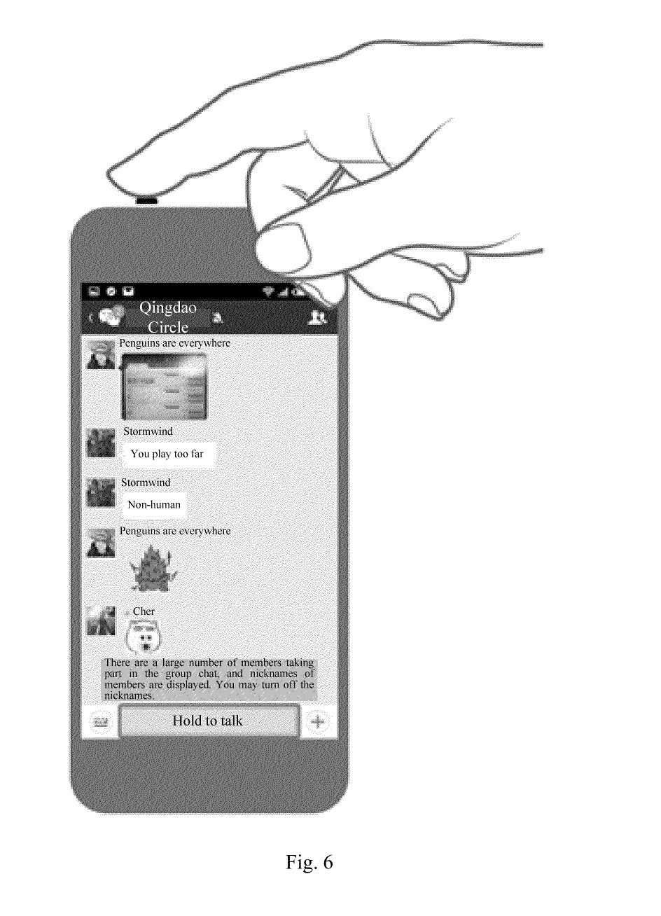

Taking an instant messaging application as an example, in a chatting interface of the instant messaging application, as shown in FIG. 6, long pressing on the physical key corresponds to long pressing on the “Hold to talk” button. After a user presses the physical key, the user may speak, and the mobile terminal may record what the user speaks. After the user releases the physical key, the mobile terminal stops recording and sends out the recorded audio data.

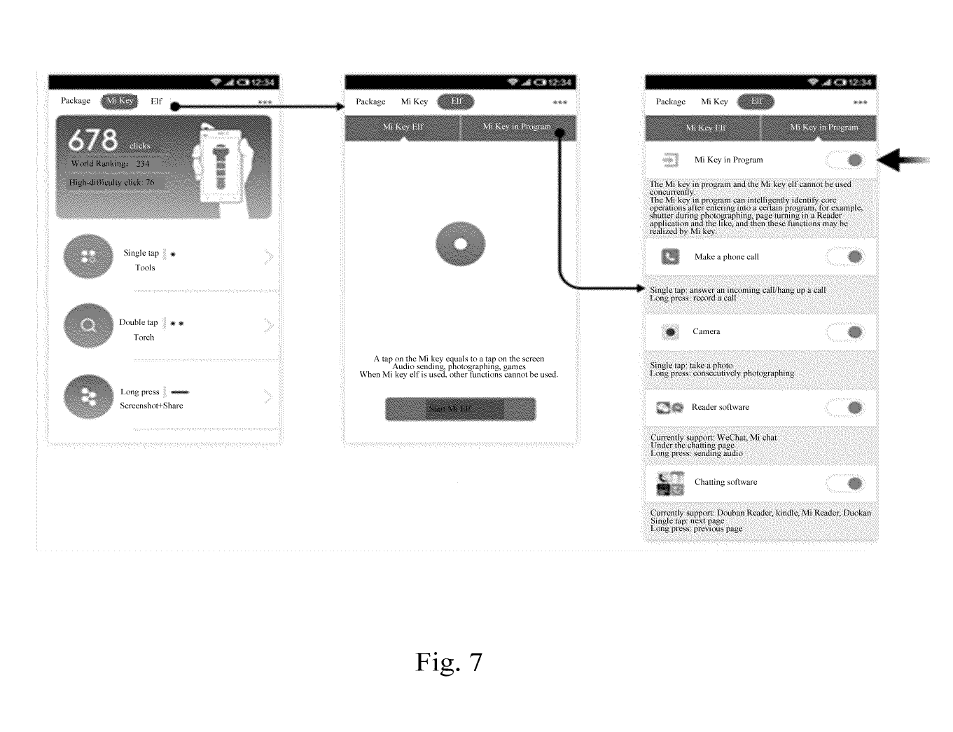

A user may configure the triggering operations on physical keys and corresponding applications and corresponding application operations in advance. As shown in FIG. 7, the physical key is exemplified as an additional control key such as a Mi key.

In a configuration interface of the Mi key application, an “Elf” button is selected, and then a “Mi key in program” button is selected. In a configuration interface of the “Mi key in program” button, whether the physical key is used in the technical solution of the present embodiment may be selected. The applications which need to employ the technical solution in the embodiment may be selected.

In an embodiment, step A2 may be realized by steps A21 and A22.

In step A21, the current interface of the current application is obtained.

In step A22, a textual identifier or a pattern identifier of the virtual button in the current interface is obtained, and the virtual button is identified.

In the embodiment, the textual identifiers or pattern identifiers of virtual buttons in interfaces of various applications are pre-stored, especially the textual identifiers or pattern identifiers of the virtual buttons which may be controlled by the physical key. After entering into an application using the physical key, whether there is a pre-set virtual button in the application interface is determined. The virtual buttons may be identified by identifying plug-ins. For example, “button” may be identified from the interface program. Alternatively, the virtual buttons may be identified by image identifying. Specifically, the interface may be considered as an image (may be obtained by screenshot), and the image identifying may be performed to identify the texts or patterns of the virtual buttons. With the image identifying manner, it is not needed to have knowledge of the program structures of the applications, and one of ordinary skills in this art only needs to know the interface pattern, which is better in compatibility and extendibility.

In an embodiment, step 102 may be realized by step B.

In step B, the application operation corresponding to the triggering operation on the physical key in the current interface of the current application is determined.

In the embodiment, the physical key may correspond to different application operations in different interfaces of the same application. As shown in FIGS. 3 and 4, in the stopwatch application, a single tap application operation may correspond to the “Start to count” button or the “Stop counting” button. In the recording application, a single tap application operation may correspond to the “Start to record” button or the “Stop recording” button. In the present embodiment, a single triggering operation on the physical key may enable various application operations for an application, and the applications may be controlled more flexibly and conveniently.

In an embodiment, step 102 may be realized by step B1.

In step B1, according to a most frequently used application operation in a history of application operations performed for the current application, the application operation corresponding to the triggering operation on the physical key in the current application is determined.

In the present embodiment, as shown in FIG. 7, when determining the application operation corresponding to the triggering operation on the physical key, the application operation may be determined according to pre-configurations such as system configuration or user configuration. Alternatively, the application operation may be determined according to identification and analysis on user behavior. For example, user application operations in the current application may be recorded in advance as a history of the applications operations. The user may perform various application operations to the current application, for example, the tap operations on buttons 1 to 3 for the current application. The correspondence between triggering operation on the physical key and application operation may be realized by different manners. In the embodiment, the triggering operation on the physical key corresponds to the most frequently used application operation, and user's behaviors may be analyzed intelligently, so that the user may use the physical key more conveniently, and the using of the physical key may comply with the customs of the user better.

In an embodiment, the correspondence between triggering operations on physical keys and application operation may change. For example, there may be two different correspondences C1 and C2.

Correspondence C1: one triggering operation on the physical key corresponds to a plurality of application operations.

Taking the stopwatch application as an example, the physical key is configured in advance so that it corresponds to an application operation of 10-second countdown. In the home page of the stopwatch application, if a user presses the physical key, the stopwatch application starts the 10-seconds countdown operation, which is equivalent to two application operations: setting a time period of 10 seconds and tapping the home page to start the countdown.

In the embodiment, a plurality of application operations may be realized by the physical key and the operations are more convenient and flexible.

Correspondence C2: triggering operations of a plurality of physical keys correspond to a single application operation.

For example, a triggering operation of single click on the additional control key concurrently with single click on the home key corresponds to a single application operation such as taping the “Recording” button in the camera application.

In the embodiment, the combination of triggering operations on a plurality of physical keys are used to control application operations. Thus, the control of more application operations can be realized, which makes the control of the mobile terminal more flexible and convenient.

The implementations for controlling an application will be described in detail with reference to several embodiments.

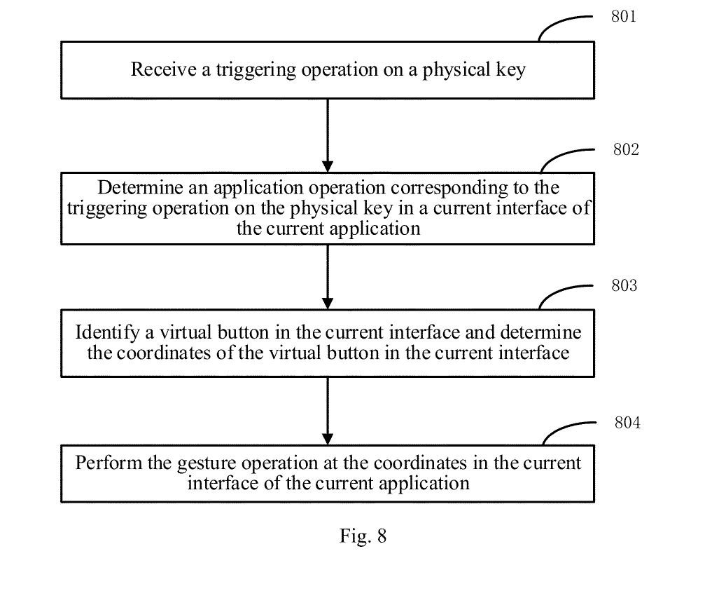

FIG. 8 is a flowchart showing a method for controlling an application according to an exemplary embodiment. As shown in FIG. 8, the method may be implemented by a mobile terminal and may include the following steps.

In step 801, a triggering operation on a physical key is received.

In step 802, an application operation corresponding to the triggering operation on the physical key in a current interface of a current application is determined.

In step 803, a virtual button is identified in the current interface and coordinates of the virtual button in the current interface are determined.

In step 804, a gesture operation is performed at the coordinates in the current interface of the current application.

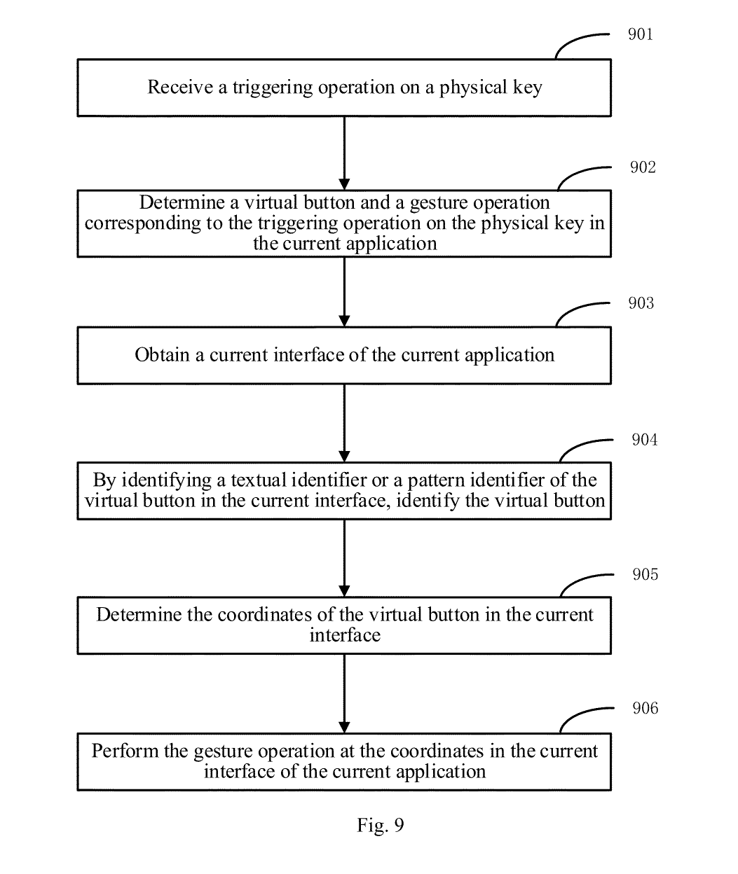

FIG. 9 is a flowchart showing a method for controlling an application according to an exemplary embodiment. As shown in FIG. 9, the method may be implemented by a mobile terminal and may include the following steps.

In step 901, a triggering operation on a physical key is received.

In step 902, a virtual button and a gesture operation corresponding to the triggering operation on the physical key in a current application are determined.

In step 903, a current interface of the current application is obtained.

In step 904, by identifying a textual identifier or a pattern identifier of the virtual button in the current interface, the virtual button is identified.

In step 905, coordinates of the virtual button in the current interface are determined.

In step 906, the gesture operation is performed at the coordinates in the current interface of the current application.

The procedure for controlling an application shall be readily appreciated from the above description, and the procedure can be performed by an apparatus in a mobile terminal or a computer. Descriptions are made with respect to the internal structures and functions of the apparatus below.

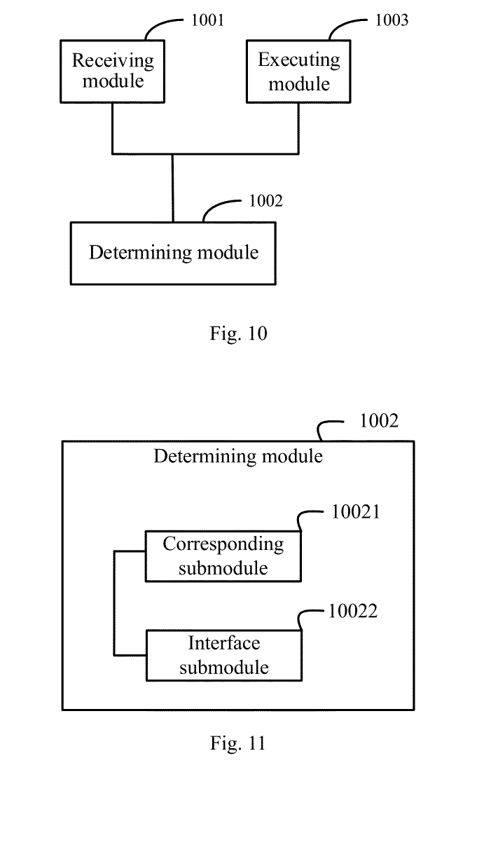

FIG. 10 is a block diagram showing an apparatus for controlling an application according to an exemplary embodiment. As shown in FIG. 10, the apparatus includes a receiving module 1001, a determining module 1002 and an executing module 1003.

The receiving module 1001 is configured to receive a triggering operation on a physical key.

The determining module 1002 is configured to determine an application operation corresponding to the triggering operation on the physical key for a current application.

The executing module 1003 is configured to perform the application operation to the current application.

In an embodiment, the application operation includes a gesture operation on a virtual button.

As shown in FIG. 11, the determining module 1002 includes a corresponding submodule 10021 and an interface submodule 10022.

The corresponding submodule 10021 is configured to determine a virtual button and a gesture operation corresponding to the triggering operation on the physical key for the current application.

The interface submodule 10022 is configured to identify the virtual button in a current interface of the current application, and determine coordinates of the virtual button in the current interface.

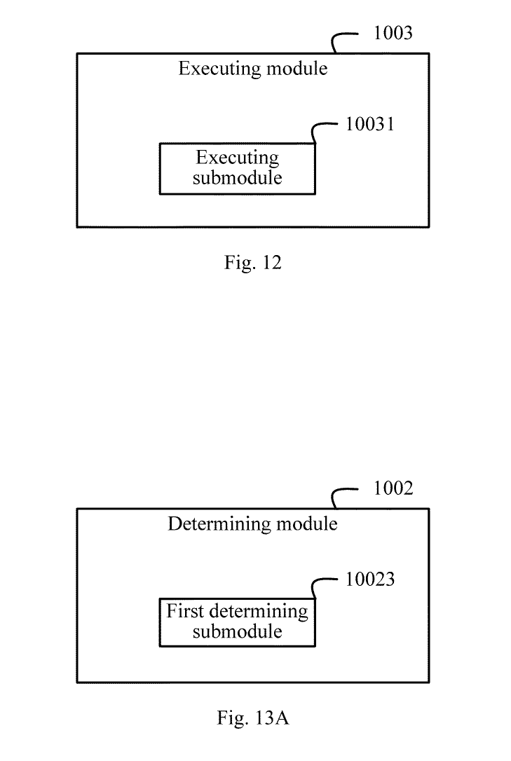

As shown in FIG. 12, the executing module 1003 includes an executing submodule 10031.

The executing submodule 10031 is configured to perform the gesture operation at the coordinates in the current interface of the current application.

In an embodiment, the interface submodule 10022 obtains the current interface of the current application and identifies the virtual button by identifying a textual identifier or a pattern identifier of the virtual button in the current interface.

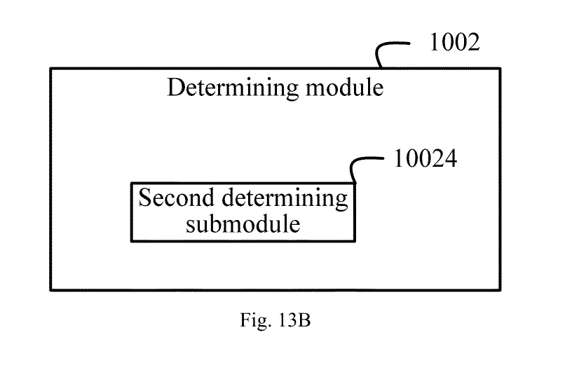

In an embodiment, as shown in FIG. 13A, the determining module 1002 includes a first determining submodule 10023.

The first determining submodule 10023 is configured to determine an application operation corresponding to the triggering operation on the physical key in the current interface of the current application.

In an embodiment, as shown in FIG. 13B, the determining module 1002 includes a second determining submodule 10024.

The second determining submodule 10024 is configured to, according to a most frequently used application operation in a history of application operations performed for the current application, determine the application operation corresponding to the triggering operation on the physical key for the current application.

In an embodiment, a triggering operation on the physical key corresponds to a plurality of application operations; or triggering operations on a plurality of physical keys correspond to an application operation.

With respect to the apparatuses in the above embodiments, specific operations performed by respective modules have been described in detail in the embodiments of the methods and therefore repeated descriptions are omitted here.

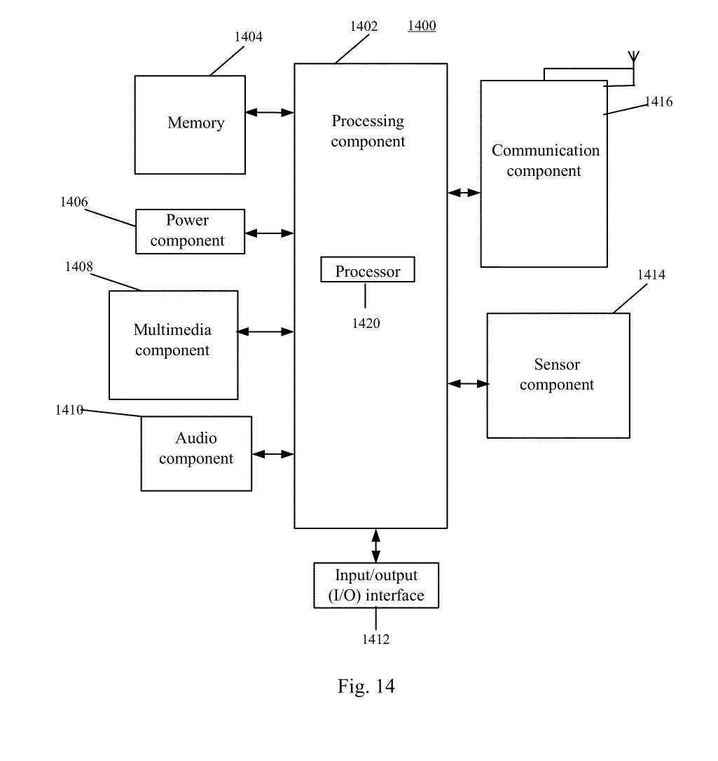

FIG. 14 is a block diagram of a device 1400 for controlling an application according to an exemplary embodiment. For example, the device 1400 may be a mobile phone, a computer, a digital broadcast terminal, a messaging device, a gaming console, a tablet, a medical device, an exercise equipment, a personal digital assistant, and the like.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400.

The multimedia component 1408 includes a screen providing an output interface between the device 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2Q or 3Q or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404, executable by the processor 1420 in the device 1400, for performing the above-described methods. For example, the non-transitory computer-readable storage medium may be a ROM, a RAM, a CD-ROM, a magnetic tape, a floppy disc, an optical data storage device, and the like.

Other embodiments of the present disclosure will be apparent to those skilled in the art from consideration of the specification and practice of the disclosure disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present invention is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for controlling an application, comprising:
receiving a triggering operation on a physical key;
determining an application operation corresponding to the triggering operation on the physical key for a current application; and
performing the application operation to the current application.

2. The method according to claim 1, wherein when the application operation comprises a gesture operation on a virtual button, determining the application operation corresponding to the triggering operation on the physical key for the current application comprises:
determining a virtual button and a gesture operation corresponding to the triggering operation on the physical key for the current application; and
identifying the virtual button in a current interface of the current application, and determining coordinates of the virtual button in the current interface of the current application.

3. The method according to claim 1, wherein performing the application operation to the current application comprises: performing the gesture operation at the coordinates in the current interface of the current application.

4. The method according to claim 2, wherein identifying the virtual button in the current interface of the current application comprises:
obtaining the current interface of the current application; and
identifying the virtual button by identifying a textual identifier or a pattern identifier of the virtual button in the current interface.

5. The method according to claim 1, wherein determining the application operation corresponding to the triggering operation on the physical key for the current application comprises:
determining the application operation corresponding to the triggering operation on the physical key in a current interface of the current application.

6. The method according to claim 1, wherein determining the application operation corresponding to the triggering operation on the physical key for the current application comprises:
determining the application operation corresponding to the triggering operation on the physical key for the current application according to a most frequently used application operation in a history of application operations performed for the current application.

7. The method according to claim 1, wherein one triggering operation on the physical key corresponds to a plurality of application operations.

8. The method according to claim 1, wherein triggering operations on a plurality of physical keys correspond to one application operation.

9. A device for controlling an application, comprising:
a processor; and
a memory for storing instructions executable by the processor;
wherein the processor is configured to perform:
receiving a triggering operation on a physical key;
determining an application operation corresponding to the triggering operation on the physical key for a current application; and
performing the application operation to the current application.

10. The device according to claim 9, wherein when the application operation comprises a gesture operation on a virtual button, determining the application operation corresponding to the triggering operation on the physical key for the current application comprises:
determining a virtual button and a gesture operation corresponding to the triggering operation on the physical key for the current application; and
identifying the virtual button in a current interface of the current application, and determining coordinates of the virtual button in the current interface of the current application.

11. The device according to claim 9, wherein performing the application operation to the current application comprises: performing the gesture operation at the coordinates in the current interface of the current application.

12. The device according to claim 10, wherein identifying the virtual button in the current interface of the current application comprises:
obtaining the current interface of the current application; and
identifying the virtual button by identifying a textual identifier or a pattern identifier of the virtual button in the current interface.

13. The device according to claim 9, wherein determining the application operation corresponding to the triggering operation on the physical key for the current application comprises:
determining an application operation corresponding to the triggering operation on the physical key in a current interface of the current application.

14. The device according to claim 9, wherein determining the application operation corresponding to the triggering operation on the physical key for the current application comprises:
determining the application operation corresponding to the triggering operation on the physical key for the current application according to a most frequently used application operation in a history of application operations performed for the current application.

15. The device according to claim 9, wherein one triggering operation on the physical key corresponds to a plurality of application operations.

16. The device according to claim 9, wherein triggering operations on a plurality of physical keys correspond to one application operation.

17. A non-transitory computer-readable storage medium having stored therein instructions that, when executed by a processor of a device, causes the device to perform a method for controlling an application, the method comprising:
receiving a triggering operation on a physical key;
determining an application operation corresponding to the triggering operation on the physical key for a current application; and
performing the application operation to the current application.
